(19) United States
(12) Patent Application Publication
(10) Pub. No.: US 2012/0209620 A1
(43) Pub. Date: Aug. 16, 2012

(54) DETECTING UNEXPECTED HEALTHCARE UTILIZATION BY CONSTRUCTING CLINICAL MODELS OF DOMINANT UTILIZATION GROUPS

(75) Inventors: SHAHRAM EBADOLLAHI, White Plains, NY (US); Jianying Hu, Bronx, NY (US); Robert K. Sorrentino, Rancho Palos Verdes, CA (US); Fei Wang, Ossining, NY (US)

(73) Assignee: INTERNATIONAL BUSINESS MACHINES CORPORATION, Armonk, NY (US)

(21) Appl. No.: 13/028,753

(22) Filed: Feb. 16, 2011

(51) Int. Cl. G06Q 50/00

(52) U.S. Cl. 705/2

(57) ABSTRACT

A system and method for identifying unexpected utilization profiles at a patient level includes determining one or more clusters that have a profile based on patient profiles and building a representative model for each cluster including demographic and clinical information. Using the model, demographic and clinical characteristics are determined which form expected utilization cluster. An expected utilization cluster for each patient, which is derived from the demographic features and the clinical characteristics, is compared against an actual utilization profile for that patient to determine whether the actual utilization profile is unexpected.

### BACKGROUND

1. Technical Field

The present invention relates to healthcare database analyses, and more particularly to systems and methods for identifying individual patients with an unexpected healthcare utilization profile.

2. Description of the Related Art

A utilization profile is a patient record that indicates when and where a patient utilized healthcare services. In many cases, this information is limited. For example, existing utilization anomaly detection algorithms use only one type of utilization (e.g., hospitalization) at a time, and do not consider combinations of utilizations. Existing utilization anomaly detection algorithms all focus on a specific disease. No existing methods provide a general framework which can be used to evaluate an overall utilization profile of a patient and determine whether some form of utilization is expected given the patients clinical and demographical characteristics.

### SUMMARY

A system and method for identifying unexpected utilization profiles at a patient level includes determining one or more clusters that have a profile based on patient profiles and building a representative model for each cluster including demographic and clinical information. Using the model, demographic and clinical characteristics are determined which form expected utilization clusters. The expected utilization cluster for each patient, which is derived from the demographic features and the clinical characteristics, is compared against an actual utilization profile for that patient to determine whether the actual utilization profile is unexpected.

A system includes a processor, and a memory coupled to the processor. The memory is configured to store a program for identifying unexpected utilization profiles at a patient level by determining one or more clusters that have a profile based on patient profiles; and building a representative model for each cluster including demographic and clinical information. The processor employs the model to determine what demographic and clinical characteristics form an expected utilization cluster, and to compare an expected utilization cluster for each patient derived from the demographic features and the clinical characteristics against an actual utilization profile for that patient to determine whether the actual utilization profile is unexpected.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for identifying unexpected utilization profiles at a patient level in accordance with one embodiment;

FIG. 2 is a flow diagram showing a system/method for identifying dominant and small clusters in accordance with one embodiment;

FIG. 3 is a plot of Adjusted Cluster Validation Index (ACVI) versus number of clusters to assist in finding a number of clusters in accordance with the present principles;

FIG. 4 is a flow diagram showing a system/method for training and testing models to predict patient utilization in accordance with one embodiment;

FIG. 5 shows bar charts for two illustrative examples of unexpected utilization profiles detected in accordance with the present principles;

FIG. 6 is a block/flow diagram showing a system/method for identifying unexpected utilization profiles at a patient level in accordance with another embodiment; and

FIG. 7 is a block/flow diagram showing a system for identifying unexpected utilization profiles at a patient level in accordance with an illustrative embodiment;

### DETAILED DESCRIPTION OF PREFERRED EMBODIMENTS

In accordance with the present principles, individual patients with an unexpected healthcare utilization profile (e.g., number of encounters of different types) can be discovered. This identifies patients whose utilization profile is dramatically different from what would be expected given the patient's clinical, demographical and other relevant characteristics. Being able to identify such cases in a timely manner is an important care management technique in that it permits care managers and medical directors to perform targeted investigations to uncover potential problems in the care delivery process, and to discover novel and effective treatment practices.

In accordance with particularly useful embodiments, systems and methods are provided that first identify dominant utilization groups (or classes) by clustering based on overall utilization profiles (combinations of different utilizations). Then, anomalies are detected by comparing each patient's expected utilization class against an actual utilization class. The embodiments provide a way to identify discontinuities in utilization variations, thus permitting detection of salient anomalies and providing an efficient method that does not need manual re-construction of algorithms for each different disease or ailment.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

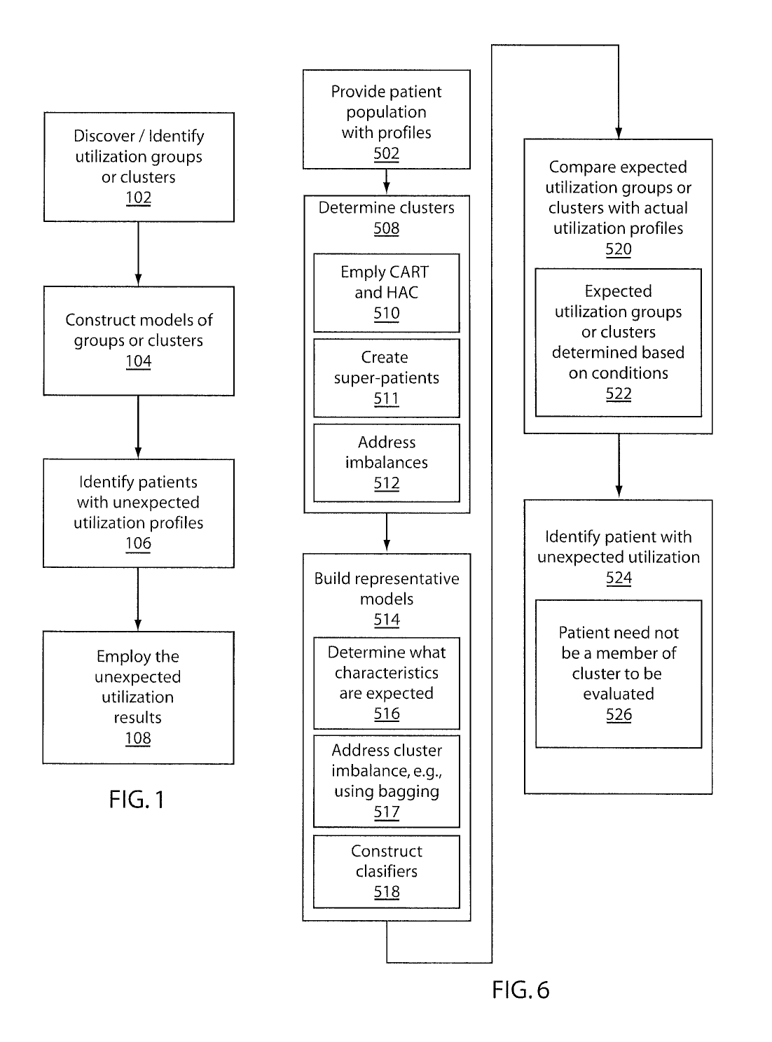

Referring now to the drawings in which like numerals represent the same or similar elements and initially to FIG. 1, a block/flow diagram shows an illustrative system/method to identify individual patients with unexpected healthcare utilization profiles. In block 102, the system/method discovers/identifies dominant utilization groups within a population using clustering analyses over patient utilization profiles. This includes a method to scale clustering analysis to a large number of patients, and a method to address a high degree of imbalance in size among groups. A method is provided to modify a number of clusters that is easily tunable to adjust to specific needs of the particular application. In block 104, construction of clinical/demographic models of each dominant and/or small utilization group is provided. This may employ machine learning methods that address the high degree of imbalance among groups. Statistical machine learning models are developed to predict utilization class using clinical characteristics (e.g., age, sex, diagnosis with severity grouping, etc.)

In block 106, patients with unexpected utilization profiles are identified by comparing a predicted utilization class using the clinical/demographical models with an actual utilization class, and further applying criteria that measures, e.g.: degree of confidence, degree of unexpectedness and degree of relevance. This includes identifying patients whose predicted utilization class is different from actual utilization class, and further satisfy high prediction confidence (e.g., high prediction probability), high degree of unexpectedness (e.g., high ratio (e.g., probability of predicted class)/(probability of true class)) and high relevance (not a borderline case), e.g., actual utilization is much closer to the mean of an actual class than the mean of the predicted class.

In block 108, the unexpected utilization may be employed in many ways. For example, physicians, clinicians, technicians, etc. may look for abnormal cases in a large population of patients. Further, an individual patient may be given statistics on how they compare with a segment of the population or the populations as a whole. Insurance companies may employ such techniques to assess premiums, etc.

In block 102, a patient utilization analysis is performed. This may employ one or more different methodologies to discover and analyze salient utilization patterns in a patient population based on historical care records, and to also discover how utilization can be linked to clinical characteristics for unusual utilization detection. A facility category of a patient encounter is provided in the “facilities” field of claims data, and provides a high level description of the type of each patient visit to a healthcare professional or location. Table I lists the frequencies of the seven most popular visit types (from the last year of a 3 year data collection effort), which account for 98% of all patient encounters. In the present illustrative embodiment, an 8 dimensional vector, called a utilization profile, is constructed to represent each patient's yearly utilization, where each dimension records the number of visits of each one of the seven dominant types, plus one dimension to account for all other visits.

TABLE I
DESCRIPTIONS OF DIFFERENT TYPES OF VISITS

| Visit Type | Description | #visits |
|---|---|---|
| 1 | PCP visit in Doctor's office | 385914 |
| 2 | Other (Specialist) visits in doctor's office | 387652 |
| 3 | Independent lab visits | 213465 |
| 4 | Outpatient hospital visits | 154079 |
| 5 | Inpatient hospital visits | 76589 |
| 6 | Patient's home | 36879 |
| 7 | Emergency room & Urgent care visits | 50767 |
| 8 | Other visits | 32111 |

The utilization profiles of the whole patient population are then analyzed in two different ways, e.g.: 1) clustering analysis to identify dominant as well as rare utilization patterns, and 2) statistical modeling linking clinical characteristics to utilization patterns.

The two-stage clustering for utilization pattern analysis will now be described. The problem of clustering of patient utilization profiles presents unique technical challenges that cannot be addressed by off-the-shelf clustering algorithms such as K-means clustering, Spectral Clustering, and Hierarchical Agglomerative Clustering (HAC). This is due to at least the following reasons. One of the most fundamental requirements of medical related research is that the results need to be stable and reproducible. However, a well known drawback of K-means is the difficulty in generating reproducible results due to its reliance on random initialization. The method employed herein should fit large scale clustering, as a data set of scale O(10⁵) or larger is being encountered. However, it is well known that HAC requires a computational burden of O(n²), while spectral clustering has the computational overhead of O(n²) to O(n³). Thus, both are computationally prohibitive for the typical healthcare data set scale.

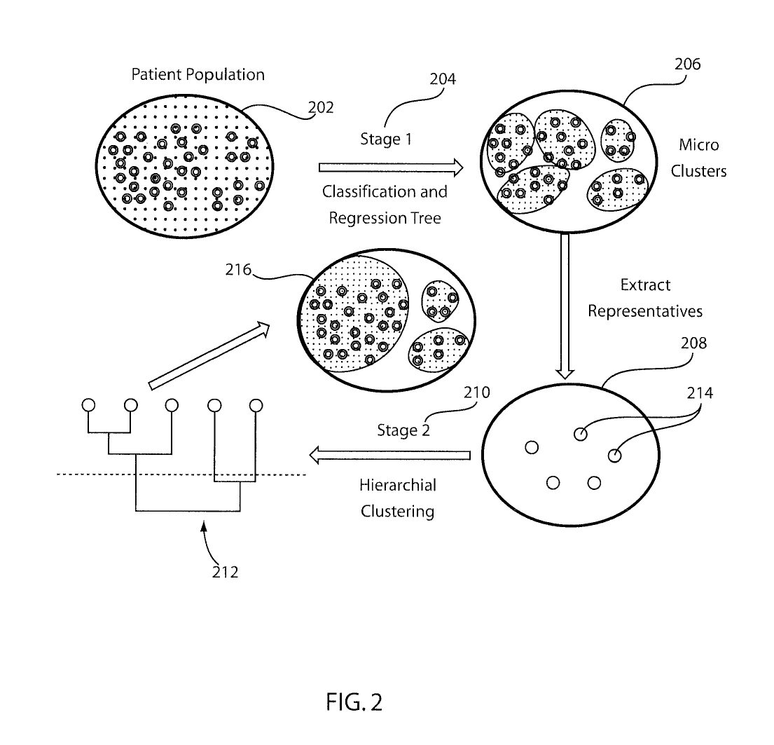

Referring to FIG. 2, in accordance with the present principles, a hybrid two-stage HAC method has been developed that retains the stability and flexibility of the HAC, while making it scalable to a large number of patients. Taking advantage of the fact that cost is closely related to utilization and is available in all claims data, we first perform over segmentation of a patient population 202 based on cost. The idea is that very similar utilization vectors should result in very close cost. By making use of cost, we can first identify a set of “micro” clusters 206 of patients with very similar utilization vectors using a highly efficient method. Each micro cluster mean is then treated as a “super patient” 214, and used in a next stage of clustering 210, where a more reliable but less scalable method of, e.g., HAC can be applied.

The efficient method selected for this purpose may include a Classification and Regression Tree (CART) method 204. Utilization vectors are treated as predictive variables and used to predict cost as a response variable. A utilization vector may be populated with, e.g., gender, age, frequency or visits, cost per visit, type of visit, etc. Utilization in this context is a healthcare visit although other events may also be employed and the present principles expanded to include other applications. In one example, an implementation may employ aspects of MATLAB™ using default parameter settings that may be modified for population clustering in accordance with the present principles. In block 206, once a tree is constructed, the mean utilization profile computed from each leaf node is treated as a super-patient 214 in block 208 and used in stage two 210 of the clustering process.

While the scalability issues are addressed by the over segmentation step described above, another modification to HAC is needed to address the issue of imbalance that is particularly pronounced in this setting. As pointed out, the vast majority of a population has relatively low utilization. Because of the significant imbalance, applying any clustering algorithm directly would lead to the smaller medium utilization clusters being “absorbed” by the very dominant low utilization cluster.

To address this issue, we incorporate domain knowledge that around 20% of the patient population is high utilization patients that need more in-depth care management and analysis, and perform two rounds of HAC (210). The 20% is illustrative and other thresholds may be employed as needed. In a first round, the bottom up cluster merging process in standard HAC is performed until a dominant cluster that accounts for around 80% of the total population is reached. A separate round of HAC is then performed on the remaining 20% or so of the population to focus on the sub-population with medium to high utilization.

One remaining question is how to determine a number of clusters for the medium to high utilization sub-population in block 212. We need to follow the following principles. The clusters should be compact, which means (1) the patient visit vectors within each cluster should be as close as possible; (2) the patient cost within each cluster should be as close as possible. Different clusters should be diverse, which means that (1) the mean visit vector of each cluster should be far apart from each other; (2) the mean cost of each cluster should be far apart from each other. In block 216, a clustered population is provided with dominant (and small) clusters.

Now, we discuss how to fulfill these criteria in practice with an illustrative example. First we denote vᵢ to be the i-th patient visit vector with associated cost cᵢ. Suppose we cluster the patients into M clusters, then the mean visit vector v̅ₘ and mean cost c̅ₘ of cluster m (denoted by π(m), m=1, 2, . . . , M) would be

$${\overline{v}}_{m} = \frac{1}{\vert π ( m ) \vert} {\sum }_{{v}_{i} ∈ π ( m )} {v}_{i} , \\ {\overline{c}}_{m} = \frac{1}{\vert π ( m ) \vert} {\sum }_{{v}_{i} ∈ π ( m )} {c}_{i} . \qquad ( 1 )$$

Then, we can compute the visit and cost compactness of cluster m as

$$\begin{matrix}{C}_{m}^{v} = \frac{1}{\vert π ( m ) \vert} {\sum }_{{v}_{i} ∈ π ( m )} {‖ {v}_{i} - {\overline{v}}_{m} ‖}^{2} & ( 2 ) \\ {C}_{m}^{c} = \frac{1}{\vert π ( m ) \vert} {\sum }_{{v}_{i} ∈ π ( m )} {‖ {c}_{i} - {\overline{c}}_{m} ‖}^{2} & ( 3 )\end{matrix}$$

Similarly, the visit and cost scatterness of cluster m as

$$\begin{matrix}{S}_{M}^{v} = {\sum }_{m = 1}^{M} {‖ {\overline{v}}_{m} - \overline{v} ‖}^{2} & ( 4 ) \\ {C}_{M}^{c} = {\sum }_{m = 1}^{M} {‖ {\overline{c}}_{m} - \overline{c} ‖}^{2} & ( 5 )\end{matrix}$$

Here,

$$\overline{v} = \frac{1}{N} {\sum }_{i = 1}^{N} {v}_{i} , \\ and$$

$$\overline{c} = \frac{1}{N} {\sum }_{i = 1}^{N} {c}_{i} .$$

Then, we can define the following two measures to measure the quality of clustering in both patient visit vectors and patient costs sense:

$${𝒟}_{m}^{v} = {𝒮}_{m}^{v} - {\sum }_{m + 1}^{M} {𝒞}_{m}^{v} , \\ {𝒟}_{m}^{c} = {𝒮}_{m}^{c} - {\sum }_{m + 1}^{M} {𝒞}_{m}^{c} \qquad ( 6 )$$

Larger values of [symbol] ₘ^{v} (or [symbol] ₘ^{c}) indicate better cluster quality (in terms of within-cluster compactness and between-cluster diversity) on patient visit vector (cost). We can define a cluster validation index for clustering with M clusters as:

$${𝒥}_{M} = \frac{1}{M} {\sum }_{m + 1}^{M} ( {𝒟}_{M}^{v} + {𝒟}_{M}^{c} ) \qquad ( 7 )$$

where [symbol] ₘ^{v} and [symbol] _{M}^{c} are treated equally. However, this may cause a problem as [symbol] _{M}^{v} and [symbol] _{M}^{c} may be of different scales.

To solve this problem, we first compute all ( [symbol] ₂^{v}, [symbol] ₃^{v}, . . . , [symbol] _{M}_{ₘₐₓ}^{v}) and ( [symbol] ₂^{c}, [symbol] ₃^{c}, . . . , [symbol] _{M}_{ₘₐₓ}^{c}) (Mₘₐₓ is the maximum possible number of clusters). Then, we normalize the vector └ [symbol] ₂^{v}, [symbol] ₃^{v}, . . . , [symbol] _{M}_{ₘₐₓ}^{v}┘ and └ [symbol] ₂^{c}, [symbol] ₃^{c}, . . . , [symbol] _{M}_{ₘₐₓ}^{c}┘ respectively so that they have unit length. In this way, [symbol] _{M}^{v} and [symbol] _{M}^{c} will be in the same scale. We call the resultant quantity Adjusted Cluster Validation Index (ACVI), which may be computed as:

$${𝒥}_{M} = \frac{1}{M} {\sum }_{m + 1}^{M} ( {\tilde{𝒟}}_{M}^{v} + {\tilde{𝒟}}_{M}^{c} ) \qquad ( 8 )$$

where [symbol] _{M}^{v}, [symbol] _{M}^{c} are the normalized values.

To select the appropriate number of clusters for a given data set, we generate the ACVI plot for a large range of clusters, and select the number of clusters that gives the maximum ACVI. A cluster is considered a dominant cluster if its size is greater than a predetermined threshold (e.g., 30).

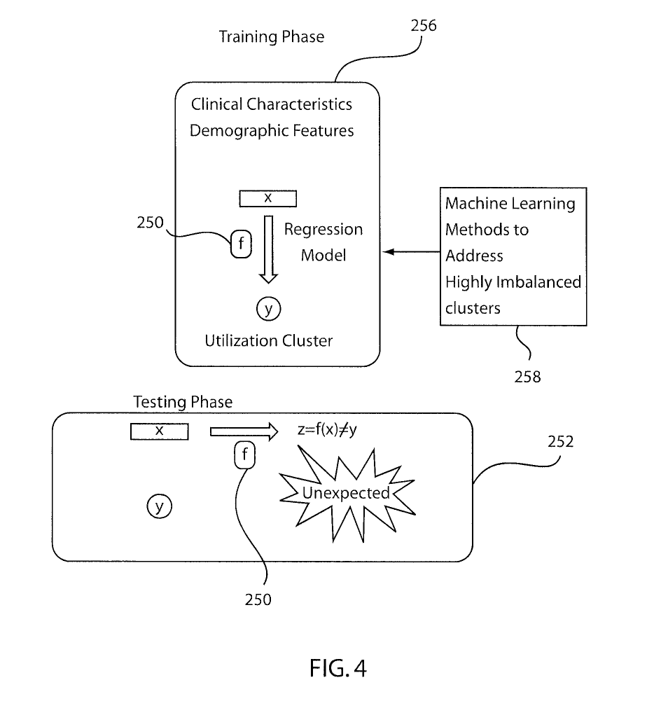

Once the dominant utilization clusters are identified in FIG. 2, clinical characteristics are associated with the utilization patterns as illustratively depicted in FIG. 4. A clinical model or classifier 250 is constructed for each utilization group.

Such models can be used to provide insights into what contributes to various utilization patterns, which can then be used to guide case management process design. Clinical characteristics can also be used to identify patients with unexpected utilization, which is defined as utilization that is different from what one would expect based on the patient's clinical and demographic characteristics, as will be described hereinafter.

The classifier 250 is constructed for each dominant utilization class (e.g., output in FIG. 2) to predict whether a patient is likely to belong to a specific utilization class given its clinical characteristics. More specifically, each patient's age, sex, and clinical characteristics such as diagnoses are used as features, and whether he/she belongs to a specific cluster is used as a label. The issue of imbalanced classes is again encountered. For a patient population, the low utilization cluster may account for around 80% of patients, whereas some very high utilization clusters only account for less than 1% of total samples. In both cases, there is a severe imbalance between the number of positive versus negative labels. This makes unbiased classification a challenging task.

To address this challenge, an asymmetric bagging scheme is employed in block 258. Bagging is a well studied technique in statistical analysis. Bagging works by independent random sampling (many times) with replacement on the data set. Then, the statistical analysis (e.g., classification, regression) is performed on each sampled set. The results are aggregated according to certain rules or thresholds.

For each dominant utilization cluster, we construct multiple binary classifiers in block 258 using Classification and Regression Tree (CART) or other machine learning techniques. This may employ a different form of the CART method than that applied in, e.g., stage 2 (210) of FIG. 2. Each classifier 250 is trained in block 256 using the whole minority group of patients and a subset of majority group of patients, where the size of the subset is the same as the size of the minor group. For a small utilization cluster, the minority group is the group of patients with positive labels, and the majority group is the group patients with negative labels. The probability that a patient belonging to cluster i is computed by the number of classifiers that predict the patient to be in this cluster divided by the total number of constructed classifiers.

Dominant utilization clusters (e.g., 80%) are determined as well as clusters for any remaining population (20%) in block 216 (FIG. 2). Expected utilization can be determined based upon where an individual patient falls within the clusters. If a patient does not fall within the clusters an unexpected utilization results.

In the following, we present the results of applying the utilization analysis methods to one year of healthcare data covering 131,941 patients as an example. The presented results are illustrative and serve to further describe the present principles. As described above, we first performed over segmentation using CART, then applied the first round of HAC to identify the dominant cluster covering close to 80% of patients. In this particular case, a cluster covering 77.3% of the population was identified. We then applied a second round of HAC to the remaining 22.7% of the population, and determined the number of clusters using the ACVI measure.

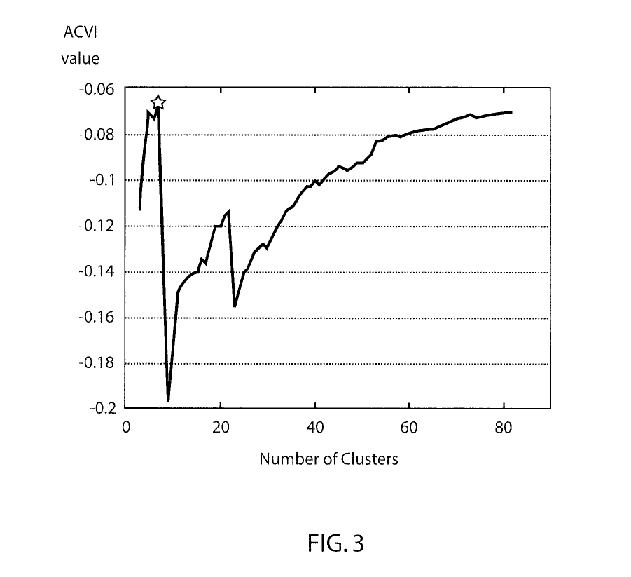

FIG. 3 shows a plot of the ACVI value versus a number of clusters in the second round of HAC. As can be seen from the plot, the curve reaches its peak point at M=7, thus the number of clusters for the second round of HAC was selected to be 7. These combined with the dominant cluster identified in the first round of HAC lead to a total of 8 clusters. The size for each cluster is shown in Table II. As seen in Table II, four dominant clusters have been identified, leading to four dominant utilization classes in this population.

TABLE II
CLUSTER SIZE

| Cluster Index | Cluster Size |
|---|---|
| 1 | 101,975 |
| 2 | 29744 |
| 3 | 111 |
| 4 | 85 |
| 5 | 14 |
| 6 | 8 |
| 7 | 2 |
| 8 | 2 |

The utilization profiles representing the centers of the clusters indicate that out of the four dominant classes, class 1 represents a large proportion of patients (77.3%) with very low utilization; class 2 represents a moderate sized group of patients with elevated level of utilization with a peak on specialist visits; class 3 and 4 are two very high utilization groups, one characterized by a large number of in-patient hospital visits, while the other characterized by an extremely high number of specialist visits.

Referring again to FIG. 4, clinical models or classifiers 250 were constructed or trained in block 256 for these four dominant utilization classes or clusters (x) using an asymmetric bagging scheme in block 258. Machine learning methods in block 258 were also employed to deal with cluster imbalancing. These models 250 were then evaluated by comparing, in a testing phase 252, a patient's predicted class (z) (i.e., the class with highest predicted probability) with its true class (y). If the predicted class z, computed using the regressive model f(x) is not equal to the actual class y then the result is unexpected.

As shown in Table III, we achieved a high predictive accuracy across all classes, with the overall accuracy close to 90%. The results indicate that 1) the utilization clusters derived are clinically meaningful, and 2) these classifiers can be used to identify unexpected utilization profiles with high confidence.

TABLE III
UTILIZATION CLASS PREDICTION ACCURACY

| Utilization Class Index | Accuracy (%) |
|---|---|
| 1 | 88.0 |
| 2 | 98.2 |
| 3 | 95.5 |
| 4 | 91.7 |

For the detection of unexpected utilization patterns using the clinical models, we conducted an experiment where we first output all the wrongly predicted patient cases, and then further filtered the list using the following criteria based on expert input.
High confidence: the predicted probability that the patient belongs to the predicted class p>0.95.
High degree of unexpectedness: the ratio of the predicted probabilities that the patient belongs to the predicted class versus his/her actual class rₚ>3.0.
High relevance: the ratio of the distance between the patient utilization profile to the cluster center of the patient's predicted class versus the cluster center of his/her actual class r_{d}>2.0.

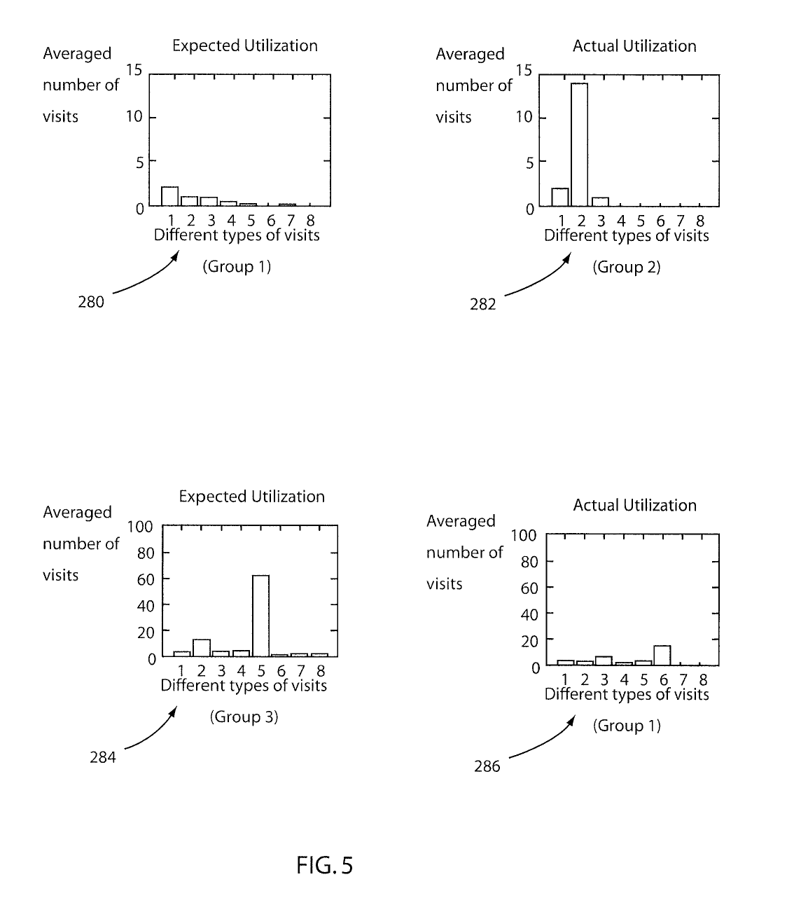

This set of filtering criteria lead to 114 unexpected utilization cases. Table IV shows two representative unusual utilization cases, whose utilization profiles are shown in FIG. 5. Patient 1 is a 27 year old female with some common minor diagnoses. A model generated an expected utilization bar chart 280. An actual utilization bar chart 282 for patient 1 is also shown. Based on the demographic and diagnoses information, the model predicted her expected utilization to be low and dominated by visits to a primary care physician (PCP) (group or class 1). However, her actual utilization is relatively high and dominated by a high number of visits to specialists (class or group 2).

For a patient 2, a model generated an expected utilization bar chart 284. An actual utilization bar chart 286 for patient 2 is also shown. On the contrary, for patient 2 who is a 78 year old male and whose diagnosis codes include some serious diseases such as congestive heart failure, the model predicted high utilization dominated by in-patient hospital visits. Interestingly, his actual utilization is relatively low and dominated by visits to the patient's home.

Identification of such cases permits medical directors or case managers to quickly spot potential anomalies in care processes and perform further investigation to identify the root causes. Such investigation could then lead to either remedial action, or identification of new and better practices that should be propagated.

TABLE IV
DISEASE DISTRIBUTION OF UNUSUAL PATTERNS WITH HCC CODE.

| Index | Cost | TC | PC | HCC Code (Visit Percentage) |
|---|---|---|---|---|
| 40969 | 1886 | 2 | dom | HCC127: Other Ear, Nose, Throat, and Mouth Disorders |
| | | | | (67.7419%) |
| | | | | HCC183: Screening/Observation/Special Exams |
| | | | | (32.2581%) |
| 65181 | 4067 | dom | 3 | HCC080: Congestive Heart Failure (24.3243%) |
| | | | | HCC166: Major Symptoms, Abnormalities (16.2162%) |
| | | | | HCC091: Hypertension (15.3153%) |
| | | | | HCC179: Post-Surgical States/Aftercare/Elective |
| | | | | (8.1081%) |
| | | | | HCC019: Diabetes with No or Unspecified |
| | | | | Complications (6.3063%) |
| | | | | HCC140: Male Genital Disorders (4.5045%) |
| | | | | HCC079: Cardio-Respiratory Failure and Shock |
| | | | | (4.5045%) |
| | | | | HCC024: Other Endocrine/Metabolic/Nutritional |
| | | | | Disorders (4.5045%) |
| | | | | HCC167: Minor Symptoms, Signs, Findings (3.6036%) |
| | | | | HCC092: Specified Heart Arrhythmias (3.6036%) |

Referring to FIG. 6, a block/flow diagram illustratively depicts a system/method for identifying unexpected utilization profiles at a patient level in accordance with another embodiment. In block 502, a patient population is provided with patient profiles. The population is preferably large, e.g., over 100,000. The patient profiles include patient utilization data (frequency of medical visits, type of visit, ailment, Health Care Coordination (HCC) codes, etc.) and patient personal information (e.g., age, gender, etc.). The patient profiles may be generated on a patient-by-patient basis.

In block 508, one or more clusters are determined that have a profile based on the patient profiles. In block 510, the patient population is preferably clustered by employing a classification and regression tree (CART) method (stage 1). A modified Hierarchical Agglomerative Clustering (HAC) method may be employed. A super-patient which has characteristics of all patients in the cluster may be provided to represent all the patients in the cluster in block 511. In block 512, cluster imbalances are addressed by employing threshold criterion and a modified Hierarchical Agglomerative Clustering (HAC) method (stage 2).

In block 514, a representative model is built for each cluster including demographic and clinical information. In block 516, the model is employed to determine what demographic and clinical characteristics determine an expected utilization cluster. Cluster imbalances may be dealt with here using, e.g., a bagging technique in block 517. In block 518, multiple binary classifiers are constructed where each classifier is trained using a whole minority group of patients and a subset of a majority group of patients, where the size of the subset is the same as the size of the minority group.

In block 520, an expected utilization cluster for each patient, which is derived from the demographic features and the clinical characteristics, is compared against an actual utilization profile for that patient to determine whether the actual utilization profile is unexpected. In block 522, the expected utilization cluster is determined using the representative model derived in block 514.

In block 524, patients with unexpected utilizations are identified by comparing each patient's expected utilization cluster and actual cluster, and further based upon one or more conditions, e.g., a probability confidence, a degree of unexpectedness and relevance that a patient belongs to a predicted class. The identification may be for purposes of finding abnormal medical conditions, system abuses, medical research, data comparisons, etc. In a particularly useful embodiment, in block 526, a patient may be compared without being a member of a patient population used for any of the clusters. In other words, the system/method may be applied to a random individual using the trained clusters to determine an unexpected utilization in accordance with the present principles. Such a patient need not be a part of the population used for training the system/method.

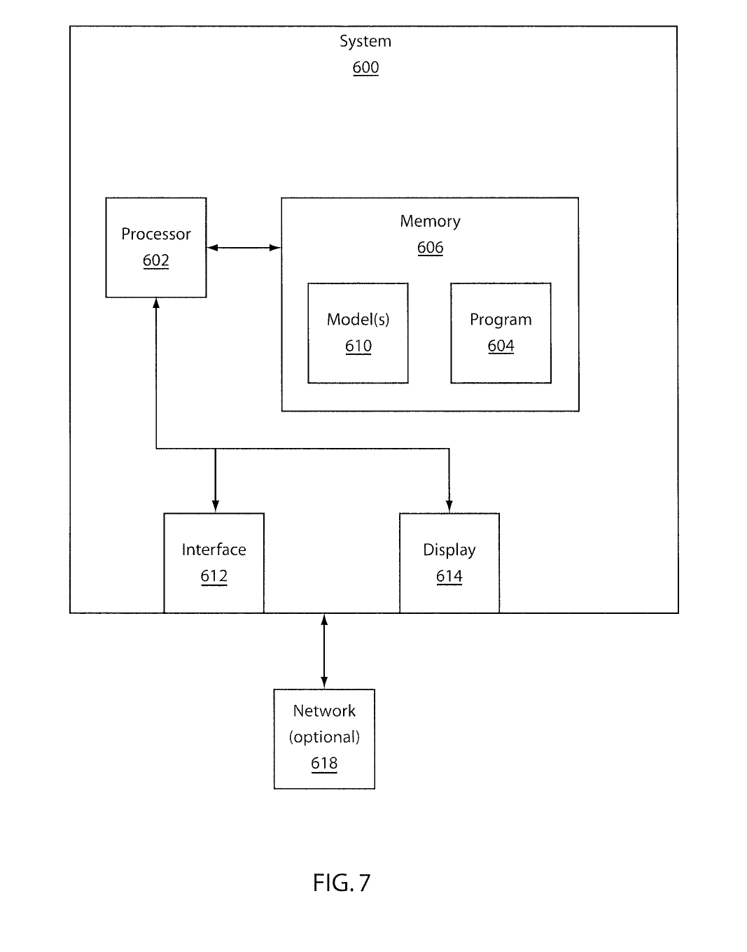

Referring to FIG. 7, a system 600 for determining unexpected healthcare utilization is illustratively shown in accordance with another embodiment. System 600 includes a processor 602 for performing computations and executing a program 604, stored in memory 606. The system 600 may be employed for training (e.g., determination clusters), testing and outputting unexpected utilization results.

Memory 606 is coupled to the processor 602 and is configured to store the program 604. The program 604 is configured to identify unexpected utilization profiles at a patient level by determining one or more clusters that have a profile based on patient profiles and building a representative model or models 610 for each cluster including demographic and clinical information.

The processor 602 employs the model 610 to determine what demographic and clinical characteristics form an expected utilization cluster, and to compare an expected utilization cluster for each patient derived from the demographic features and the clinical characteristics against an actual utilization profile for that patient. This determines whether the actual utilization profile is unexpected. The system 600 and program 606 are configured to perform the methods as described throughout this disclosure. The system 600 stores or includes machine learning, CART, HAC, or any other methods needed in accordance with the present principles.

The system 600 includes an interface 612 and a display 614 which permit a user to interact with the system 600 to perform patient searches for patients with unexpected utilization information, to perform utilization comparisons between patients in different populations (e.g. between patients in one hospital, in a state or region, etc., or a whole population of patients), etc. The system 600 may output reports for individual patients or identify which patients fall inside or outside of identified clusters. The system 600 may be available over a network 618 for convenient use by subscribers.

Having described preferred embodiments for detecting unexpected healthcare utilization by constructing clinical models of dominant utilization groups of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for identifying unexpected utilization profiles at a patient level, comprising:
determining one or more clusters that have a profile based on patient profiles;
building a representative model for each cluster including demographic and clinical information;
using the model to determine what demographic and clinical characteristics determine an expected utilization cluster; and
comparing an expected utilization cluster for each patient derived from the demographic features and the clinical characteristics against an actual utilization profile for that patient to determine whether the actual utilization profile is unexpected.

2. The method as recited in claim 1, wherein determining one or more clusters includes clustering a patient population by employing a classification and regression tree (CART) method.

3. The method as recited in claim 2, wherein clustering includes employing a modified Hierarchical Agglomerative Clustering (HAC) method.

4. The method as recited in claim 2, wherein clustering includes determining a super-patient having characteristics of all patients in a cluster.

5. The method as recited in claim 1, further comprising addressing cluster imbalances by employing threshold criterion and a modified Hierarchical Agglomerative Clustering (HAC) method.

6. The method as recited in claim 1, wherein building a representative model includes constructing multiple binary classifiers

7. The method as recited in claim 6, wherein each binary classifier is trained using a whole minority group of patients and a subset of a majority group of patients, where a size of the subset is the same as a size of the minority group.

8. The method as recited in claim 1, further comprising identifying patients with unexpected utilizations.

9. The method as recited in claim 1, wherein the actual utilization profile is unexpected based upon one or more of a probability confidence, a degree of unexpectedness and relevance that a patient belongs to a predicted class.

10. The method as recited in claim 1, wherein a patient is compared in the comparing step without being a member of a patient population employed in any of the clusters.

11. A computer readable storage medium comprising a computer readable program for identifying unexpected utilization profiles at a patient level, wherein the computer readable program when executed on a computer causes the computer to perform the steps of:
determining one or more clusters that have a profile based on patient profiles;
building a representative model for each cluster including demographic and clinical information;
using the model to determine what demographic and clinical characteristics determine an expected utilization cluster; and
comparing an expected utilization cluster for each patient derived from the demographic features and the clinical characteristics against an actual utilization profile for that patient to determine whether the actual utilization profile is unexpected.

12. The computer readable storage medium as recited in claim 11, wherein determining one or more clusters includes clustering a patient population by employing a classification and regression tree (CART) method.

13. The computer readable storage medium as recited in claim 11, wherein building a representative model includes constructing multiple binary classifiers where each classifier is trained using a whole minority group of patients and a subset of a majority group of patients, where a size of the subset is the same as a size of the minority group.

14. The computer readable storage medium as recited in claim 11, wherein the actual utilization profile is unexpected based upon one or more of a probability confidence, a degree of unexpectedness and relevance that a patient belongs to a predicted class.

15. The computer readable storage medium as recited in claim 11, further comprising addressing cluster imbalances by employing threshold criterion and a modified Hierarchical Agglomerative Clustering (HAC) method.

16. The computer readable storage medium as recited in claim 11, wherein a patient is compared in the comparing step without being a member of a patient population employed in any of the clusters.

17. A system, comprising:
a processor;
a memory coupled to the processor, the memory configured to store a program for identifying unexpected utilization profiles at a patient level by:
determining one or more clusters that have a profile based on patient profiles; and
building a representative model for each cluster including demographic and clinical information;
the processor employing the model to determine what demographic and clinical characteristics form an expected utilization cluster, and to compare an expected utilization cluster for each patient derived from the demographic features and the clinical characteristics against an actual utilization profile for that patient to determine whether the actual utilization profile is unexpected.

18. The system as recited in claim 17, wherein a patient population is clustered by employing a classification and regression tree (CART) method.

19. The system as recited in claim 17, further comprising an interface configured to permit a user to enter patient information to find unexpected utilization for one or more patients.

20. The system as recited in claim 17, wherein the representative model is trained using machine learning.

21. The system as recited in claim 17, wherein the actual utilization profile is unexpected based upon one or more of a probability confidence, a degree of unexpectedness and relevance that a patient belongs to a predicted class.

22. The system as recited in claim 17, further comprising a threshold criterion and a modified Hierarchical Agglomerative Clustering (HAC) method employed to address cluster imbalances.

23. The system as recited in claim 22, further comprising multiple binary classifiers constructed to classify utilization clusters.

24. The system as recited in claim 17, wherein the patient profiles are generated on a patient by patient basis.

25. The system as recited in claim 17, wherein a patient is compared to clusters without being a member of a patient population employed to create the clusters.
